(19) United States
(12) Patent Application Publication
(10) Pub. No.: US 2015/0034199 A1
(43) Pub. Date: Feb. 5, 2015

(54) LINING HOSE FOR THE REHABILITATION OF FLUID-CARRYING LINE SYSTEMS

(71) Applicant: SML Verwaltungs GmbH, Rohrbach (DE)

(72) Inventor: Christian Klinger, Ampfing (DE)

(21) Appl. No.: 14/379,723

(22) PCT Filed: Feb. 18, 2013
(86) PCT No.: PCT/EP2013/053198

§ 371 Date: Aug. 19, 2014

(30) Foreign Application Priority Data
Feb. 23, 2012 (DE) 10 2012 003 393.1

(51) Int. Cl. F16L 55/165

(52) U.S. Cl. CPC F16L 55/1656
USPC 138/97

(57) ABSTRACT

Pre-fabricated lining hose for the rehabilitation of fluid-carrying line systems comprising at least one fiber strip impregnated with a one-component epoxy resin which is curable by chain growth polymerization.

The present invention relates to a pre-fabricated lining hose for the rehabilitation of fluid-carrying line systems.

Processes for the rehabilitation of line systems in which e.g. liquid or gaseous media are transported are known and have been described repeatedly in the prior art.

At first processes have to be mentioned in this regard wherein segments of the line which comprise defects or which are damaged are replaced by new line segments. However, this is laborious and not always possible. For example, it is normally not allowed to separate or cut out line segments and replace same by new segments arbitrarily in pressurized line systems, since the compressive strength may be endangered thereby. Accordingly, in such systems often a significantly bigger part of the respective line system has to be replaced than would be necessary due to the damage.

For line systems laid underground same have to be laboriously excavated for this type of rehabilitation and after rehabilitation they have to be buried again. In particular in the case of rehabilitation of sewer lines beneath traffic ways this means massive disturbances of the traffic flow for extended periods of time and significant costs.

A particularly elegant process for the rehabilitation of fluid-carrying line systems, e.g. sewer lines or similar line systems, which has been gaining increasing importance in the recent past consists in introducing a flexible fiber hose, which serves as a lining hose (so called “liner”) impregnated with a curable resin into the line system, expanding same therein so that it intimately comes into contact with the inner wall of the line system and thereafter curing the resin.

The manufacture of such a lining hose is described e.g. in WO 95/04646.

As curable resins unsaturated polyester resins or vinyl ester resins are preferably used in the known processes, which may be dissolved e.g. in styrene and/or an acrylic ester.

These unsaturated polyester or vinyl ester resins may be cured thermally (usually with peroxide catalysts) or with radiation, e.g. by UV radiation with photo initiators as for example described in EP 23634. Furthermore, so called combination-curing systems including a peroxide initiator for thermal curing in combination with photo-initiators are possible and have proved to be advantageous in particular for lining hoses with large wall thicknesses of the lining hose. A process for such a combination-curing is described e.g. in EP 1262708. Unsaturated polyester or vinyl ester resins show a shrinkage upon curing, however, which may detrimentally impact the stability of the rehabilitated line system during later use.

This shrinkage may be reduced through the addition of glass fibres or the like in respective amounts. This, however, detrimentally impacts the flexibility of the lining hose, which may be disadvantageous in particular when rehabilitating line systems with small interior diameter (such as connecting lines to buildings in waste water collecting systems). The lining hoses are usually introduced into such line systems by everting (often referred to as inversion process). With high contents of strengthening fillers, the inversion processes become increasingly difficult. In particular for such line systems, however, it is important that no hollow space (as may be created through the shrinkage upon curing) is formed between the lining hose introduced and the original wall of the line system as this detrimentally influences the stability of the line system (the pressure load onto the walls of the line system in such systems increases with decreasing diameter of the line system if the wastewater volume is kept constant) and, in addition, the free cross-section of the line is reduced, which is also undesirable. Furthermore, tension cracks may be formed as a consequence of significant shrinkage and thereby negatively influence the stability.

Epoxy resins, which are obtained through poly-addition upon curing show a significantly better shrinkage behavior upon curing compared to unsaturated polyester resins and for these reasons would be principally advantageous for such problem situations.

From DE 201 21 554 a hose system for the rehabilitation of pressure lines is known according to which the hose system is sealingly attachable to the interior wall of the line to be rehabilitated, whereby the hose system is impregnated with a two-component epoxy resin. Because of the very short usable time of the resin, same has to be added immediately prior to the introduction into the line system.

Epoxy resins are only usable during the so called pot-life—and same is relatively short for two-component epoxy resins. The two components of a two-component epoxy resin are thus usually mixed at the construction site and thereafter introduced into the lining hose. This leads to a number of problems, however.

For a uniform curing of epoxy resins curing through polyaddition it is of utmost importance to maintain an exact stoichiometric balance between hardener (initiator) and resin. If same is not given, the curing is incomplete (if an unsufficient amount of initiator is used) or an embrittlement is observed (if the initiator is used in excess).

The uniform introduction of the resin into the lining hose at the construction side constitutes an additional challenge. The lining hose usually is not produced at the side of introduction into the line system but is supplied to the construction side in pre-fabricated form and is thereafter introduced into the fluid-carrying line system to be rehabilitated. In the case of use of unsaturated polyester resins for impregnating the fiber strips, in particular in accordance with the winding process e.g. as described in W095/04646, the polyester resins can be incorporated in the fiber strips used already during the winding process or the fiber strips to be wound may be impregnated prior to the winding process with the resin. This enables a better control of the homogenous and uniform distribution of the resin, which is important for the curing following later. Therefore it is advantageous to introduce the resin already during the manufacture of the lining hose and to transport the impregnated lining hose to the construction site and introduce same there into the line system. This is basically impossible in the case of two-component epoxy resins as their pot-life is much too short and the lining hose would prematurely cure prior to the arrival of the construction site and thus could be no longer be introduced into the line system to be rehabilitated.

Finally, there is always the risk that unforeseen delays curing the introduction of the lining hose may occur after introduction of the resin and thereby the pot-life of the resin is exceeded before the lining hose can be placed in the desired position. As a result thereof, the lining hose has to be laboriously removed from the line system, which due to the cross-linking occurred through the curing is only possible through destruction of the lining hose with respective labour and expenses.

The problems outlined above have until today prevented that two-component epoxy resins have been used to a large extent in lining hoses for the rehabilitation of fluid-carrying systems.

Principally, epoxy resins may be cured through poly-addition or catalytically. The photochemically initiated cationic curing of epoxy resins is known and has been described in the literature. In particular in the area of dental application compositions such systems are used, which are cured by the use of photo initiators, which comprise an onium salt and a sensibilizer. Only by way of example EP 789721 and EP 1 252 551 may be mentioned here.

However, the shrinkage upon curing of such systems is usually higher compared to epoxy resins curing through poly-addition.

From U.S. Pat. No. 5,017,258 a process for the interior lining of pipelines is known, in accordance with which a substrate comprising a one-component epoxy resin and a hardener on the basis of imidazoles unsubstituted in 1-position distributed in the epoxy resin and being in contact with same, is introduced into a line and thereafter cationically cured. The pot-life of the systems described at a temperature of 25° C. is in the range of less than 24 hours, i.e. an introduction of the resin already during manufacture of the lining hose and prior to the transport thereof to the place of use is impossible with the systems described, since a premature curing would occur.

One-component epoxy resins differ from two component systems principally in the fact, that all the components for curing are contained in the resin. A mixing of two components with the problems associated therewith is not necessary. The curing occurs through activation of the hardener, which is present in latent form. However, usual latent hardeners, e.g. dicyandiamide, often require temperatures for curing above 150° C., in many cases even exceeding 200° C. At such temperatures the polymer foils usually contained in the lining hoses are stable only to a very limited extent. Furthermore, the heating of a lining hose with a diameter as is usually found in sewer systems requires significant amounts of thermal energy, which is economically disadvantageous. Such high temperatures can be realized and maintained at construction sites only with difficulties.

It was therefore an object of the present invention to provide pre-fabricated lining hoses for the rehabilitation of fluid carrying line systems, which on one hand are easy to manufacture and may be easily introduced into the line system without the necessity to introduce components (e.g. resin or components of the resin) into the lining hoses at the construction site and which on the other hand show a good dimensional stability after incorporation into the line system to be rehabilitated. To reduce thermal pressure of the lining hoses during curing it should be possible to carry out same at moderate temperatures, preferably not exceeding 100-120° C.

This object is achieved in accordance with the present invention through the lining hoses in accordance with claim 1.

Preferred embodiments of the present invention are described in the dependent claims and the following detailed description.

The pre-fabricated lining hoses in accordance with the invention comprise at least one fiber strip impregnated with a resin, whereby the resin is a one-component epoxy resin comprising an initiator for a chain growth polymerization with an activation temperature of at most 60° C., which initiator is present in the epoxy resin in isolated form.

The term chain growth polymerization is intended to encompass all polymerization processes in which one molecule after the other is added to the reactive chain end. Different to the step growth polymerization chain segments present cannot combine to bigger units. Members of the group of chain growth polymerization processes are radical polymerization and ionic polymerization as well as the coordination polymerization, whereas polyadditions and polycondensations are step growth polymerization processes. For epoxy resins the radical and the ionic polymerization as chain growth polymerization processes play a role.

The term pre-fabricated in the context of the present invention is intended to comprise lining hoses, in which the impregnation of the fiber strips takes place during the manufacture of the lining hose and the impregnated lining hoses are transported from their place of manufacture to their place of use and are introduced into the line system to be rehabilitated without the addition of additional components.

To achieve this, the one-component epoxy resins comprised in the lining hoses in accordance with the invention should be usable over a period of at least 48 hours, preferably of at least 100 hours and in particular of at least 30 days at a temperature of preferably 20° C. without the occurrence of a significant curing, which can be monitored through an increase of the viscosity of the resin. With other words, they should have a respective long-time storage stability. The term storage stability in the context of the present invention is intended to generally denote the time period, within which, at a temperature of 10° C., the initial viscosity of the epoxy resins doubles. The control of the viscosity increase during storage is of importance, since the lining hose can only be introduced into the line system to be rehabilitated and can only be brought into contact with the wall of the line system up to a certain maximum viscosity of the lining hose without the danger of damaging the lining hose or it becoming impossible to achieve a fitting contact to the wall because of the lack of sufficient flexibility of the lining hose.

The term fluid-carrying line system in the context of the present invention is intended to denote line systems of any type for the transport of liquid or gaseous media, which may be operated at reduced pressure, normal pressure or above atmospheric pressure. Just by way of example pipelines of any type, tubular line systems for the transport of media in chemical facilities and production sites, pressure lines such as pressure water lines and drinking water lines and in particular also wastewater systems, which are laid underground respectively not visible may be mentioned here. The lining hoses in accordance with the invention are in particular suitable for the rehabilitation of water or wastewater lines in sewer systems. The lining hoses in accordance with the present invention are particularly suitable for the rehabilitation of branch lines (e.g. connecting lines to buildings or the like) in sewer systems, which have a small inner diameter and which are introduced through inversion (by everting), because a pulling through of the lining hose through the line system to be rehabilitated cannot be realized.

The lining hoses in accordance with the present invention comprise one or several fiber strips, which are impregnated with a one-component epoxy resin which comprises an initiator, which effects the homopolymerization of the epoxy compound comprised in the epoxy resin.

In accordance with the invention the initiator has an activation temperature of at most 60° C. and is present in the epoxy resin in isolated form.

The term activation temperature, when used herein, is intended to denote the temperature at which the initiator in the one-component epoxy resin starts to react (as measured by DSC (differential scanning calorimetry) at a heating rate of 10° C./min), which can be easily measured also through the increase in viscosity.

The initiators are used in the lining hoses in accordance with the present invention in masked form. The term masking, as used herein, is to be understood that the initiator is isolated from the epoxy resin to be cured at low temperatures, i.e. it cannot come into direct contact with the epoxy groups, which prevents a premature curing. Through heating to the desired curing temperature the isolation of resin and initiator is removed and curing occurs. The isolation or separation of resin and initiator may be achieved e.g. by encapsulation or coating the initiator with a wax or a polymer with a melting point in the vicinity of, preferably slightly below, but in any case not above the desired curing temperature. Preferably the material used for encapsulation or coating has a melting point which is 1 to 30, preferably 2 to 20° C. below the intended curing temperature. The initiator can also be isolated from the resin to be cured by coating same onto a carrier. It is in any case important to reliably secure that prior to the heating to the curing temperature initiator and resin may be reliably isolated from each other to avoid the undesired premature curing.

The skilled person will, after he has set the curing temperature taking into consideration the individual conditions of the case, select a suitable wax or other material suitable for coating or encapsulation with a melting point preferably in the vicinity, in particular 1 to 30°, particularly preferred 2 to 20° below the intended curing temperature.

Processes for the encapsulation of solids or liquid components (some of the initiators are liquid at room temperature) with a meltable sheath or wrapping are known per se to the skilled person and described in the literature so that further detailed information is not necessary here. Just by way of example, mixing using a drum mixer, various spraying processes, vaporization methods or precipitation methods and micro encapsulation methods may be mentioned here. The skilled person is not subject to specific limitations when selecting the method for coating or encapsulating the initiator.

Masked initiators, different to unmasked initiators, are practically inert at temperatures of 70° C., preferably of 60° C. or less. Only after heating to temperatures above the activation temperature, usually more than 50° C., a curing by polymerization occurs with a velocity which is sufficient for the practical use.

The masked initiators generally are used in amounts in the range of from 0.01 to 20% by weight, preferably of from 0.05 to 5% by weight, based on the entire weight of resin to be cured, masked initiator and optionally additional components.

Suitable initiators are anionic initiators e.g. imidazoles like methyl imidazole or phenyl imidazole, tertiary amines and alcoholates, or cationic initiators, such as iodonium salts and triaryl sulfonium salts.

Initiators, which cannot initiate a poly-addition, i.e. which do not comprise at least two active hydrogen atoms as required for an addition polymerization, are preferably used.

The curing temperatures, i.e. the temperatures at which the epoxy resin in the lining hose can be cured are at least 50° C., preferably at least 60° C., particularly preferably in the range of approximately 70 to approximately 90° C. for the preferred curing with hot water or steam. The energy required for curing can principally also be introduced in any other manner, e.g. through IR-radiation or other known methods.

The lining hoses in accordance with the present invention are not subject to particular limitations as far as the epoxy resins are concerned. Accordingly, all epoxy resins, which are commercially available in a large number may be taken into consideration, which usually comprise more than one 1,2-epoxide group (usually referred to as oxirane group) and which may be saturated, unsaturated, aliphatic, cycloaliphatic, aromatic or heterocyclic and which are susceptible to chain growth polymerization.

Respective resins are available from epoxide compounds with on average more than one epoxide group per molecule, optionally with the concomitant use of hydroxyl group containing further monomers.

Suitable epoxides are e.g. cyclohexene oxide groups containing compounds such as epoxy cyclohexane carboxylates, as described in detail in U.S. Pat. No. 3,117,099, which is incorporated by reference in its entirety for further details.

Another suitable group of epoxides are glycidyl ether derivatives as available through reaction of phenol derivatives with several hydroxyl groups with epichlorohydrine. Included therein are in particular the diglycidyl ethers of 2,2-dimethyl-2,2-di-(4-hydroxyphenyl)-propane (Bisphenol A) respectively. 2,2-di(4-hydroxyphenyl)-methane (Bisphenol F) or 4,4′-dihydroxydiphenylsulfone (Bisphenol S). Aliphatic epoxide compounds such as epoxidized fatty acid derivatives are also suitable.

Octadecenyl oxide, styrene oxide, cyclohexene oxide, vinyl cyclohexene oxide, limonen dioxide, 1-omega-bis(3,4-epoxycyclohexyl-methyloxy)alkanes, glycidol, glycidyl methacrylate, vinylcyclohexene dioxide, 3,4-epoxy-6-methylcyclohexylmethyl-3,4-epoxy-6-methylcyclohexene carboxylate, 3,4-epoxycyclohexylmethyl-3,4-epoxycyclohexene carboxylate, bis-(3,4-epoxy-6-methylcyclohexylmethyl)adipate, bis-(3,4-epoxy-4-methylcyclohexane carboxylic acid)hexyldiester, 1,3-bis(3,4-epoxycyclohexylethyl)tetramethyldisiloxane and bis-(2,3-epoxycyclopentyl)ether are expressly mentioned as examples and are partly reproduced below

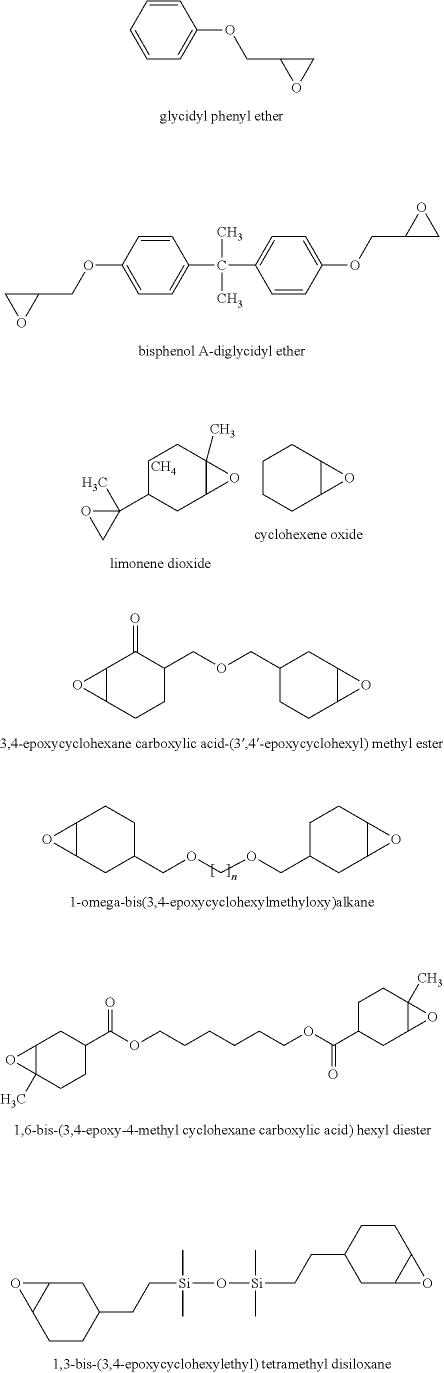

Furthermore, epoxy resins of the phenol-novolak type, epoxy resins of the cresol-novolak type, epoxidized products of dicyclopentadiene-modified phenolic resins, aromatic epoxy resins with naphthalene scleton and epoxy resins with a fluorene sceleton, epoxidized products of 2,2′, 6,6′-tetramethyl bisphenol, aliphatic epoxy resins such as neopentylglycol diglycidyl ether and 1,6-hexane diol glycidyl ether are mentioned. Finally, epoxy resins with a heterocyclic ring may be mentioned, e.g. triglycidyl cyanurate. Respective products have been described in a multiplicity of different variants in the literature and are commercially available.

In some cases it has been shown to be advantageous to use monomers with more than one hydroxy group in the molecule in addition to epoxides susceptible to chain growth polymerization. These epoxides yield products with a higher degree of curing, since chain transfer reactions may occur (although this is not a pure chain growth polymerization anymore, such a type of polymerization is intended to be included in the sense of the present invention in the respective term).

Particularly preferred representatives of compounds with more than one hydroxyl group in the molecule are aliphatic alkylene glycols and polyoxyalkylene glycols. Further examples are disclosed in WO 96/13538, which is Incorporated by reference herein in its entirety for this purpose.

If combinations of epoxides with more than one epoxy group in the molecule and compounds with more than one hydroxy group in the molecule are used, the equivalent ratio of epoxy groups to hydroxy groups usually is in the range of from 0.1 to 10 to 10 to 0.1, preferably of from 0.5 to 5 to 5 to 0.5 and in particular of from 0.7 to 1 to 1 to 0.7, with mixtures with an equivalent ratio in the range of from 0.9 to 1 to 1.1 to 1 being particularly preferred. A small excess of hydroxy groups has shown to be particularly advantageous.

The epoxy resin in the lining hoses in accordance with the invention may comprise fillers to improve the mechanical properties of the cured liner.

Reactive thinners such as butane diol glycidylether, or monoglycidylethers of higher alcohols, butyl glycidylether, 2,2,4-trimethylpentyl glycidylether, phenyl glycidylether, kresyl glycidy lether oder glycidyl esters, to mention only a few examples may be added to the epoxy resins to reduce the viscosity. Respective products are known to the skilled person and they are also commercially available.

An advantage of the masked initiators in the pre-fabricated lining hoses in accordance with the invention is that by suitable selection of the material of the masked envelope or sheath and of the particle size the disposability in the resin can be influenced and thus a stable suspension in the resin matrix can be achieved.

The lining hoses in accordance with the invention comprise at least one fiber strip impregnated with a one-component epoxy resin. As fiber strips principally any products known to the skilled person in the form of textiles, knitted fabrics, mats or fleeces, which may comprise fibers in the form of long endless fibers or in the form of short fibers, are suitable. Respective products are known to the skilled person and are commercially available in a great variety.

The term textile, as used herein, denotes generally sheet-like textile products of at least two orthogonally crossed fiber systems, wherein the so-called warp extends in the longitudinal direction and the so-called weft orthogonal thereto.

The term knitted fabric generally denotes textile products produced through the formation of meshs.

Fiber ravings or rovings are a processing variant of fibers, in which the fibers are not woven, but oriented parallel to each other in a chemical carrier compound (the matrix) and are fixed in place through cover foils on the upper and the lower surface. Rovings, due to the parallel orientation of the fibers usually show a pronounced anisotropy of stiffness or rigidity in the direction of the orientation and perpendicular thereto, which may be of interest for certain applications.

A fleece consist of fibers loosely laid next to each other without being connected. The rigidity of a fleece solely rests on the fiber-inherent attraction, but may be influenced through further processing. In order to get a fleece suitable for use and processing, the fleece is usually solidified, for which solidification several methods may be used.

Fleeces differ from textiles or knitted fabrics, which are characterized by a particular and defined laying of the single fibers or filaments. Fleeces, in contrast, consist of fibers the orientation of which can only be described with statistical methods. The fibers are randomly oriented in the fleece. The English term non-woven thus clearly differentiates fleeces from textiles. Fleeces are differentiated according to the fiber material (e.g. the polymer in case of chemical fibers), the bonding process, the fiber type (staple or endless fibers), the denier of the fibers and the fiber orientation. The fibers may be oriented in a preferred direction or may be entirely stochastically oriented in the randomly oriented fleece.

If the fibers do not have a preferred direction for their orientation, the term isotropic fleece is used. If the fibers are oriented in one direction and more often than in another direction, the term anisotropy is used.

In the frame of the present invention felts are also considered to be fiber strips. A felt is a sheet-like product based on unsorted and difficult to separate fiber goods. In principle, felts are thus textiles which are not woven: Felts are usually obtained from chemical or plant-based fibers through dry needling (so called needled felts) or through solidification with water beams which exit from a beam with dies (die beam) under high pressure. The individual fibers in a felt are interlooped with each other in a random manner.

Needled felts are usually mechanically manufactured with a multiplicity of needles and flukes (barbs), wherein the barbs or flukes are positioned in reverse direction compared to a harpoon. Thereby, the fibers are pressed into the felt and the needle can be easily pulled out. Through repeated stitching the fibers are looped (entangled) with each other and thereafter optionally treated chemically or with water vapor.

Felts, as fleeces, may be manufactured from basically all natural or synthetic fibers. Besides needling or in addition to needling the fibers is also possible to hook the fibers with a pulsed water beam or a binding agent. The letter methods are in particular suitable for fibers without scale structure such as polyester or polyamide fibers.

Felts show a good temperature stability and are usually hydrophobic, which may be an advantage in fluid-carrying systems.

The length of the fibers used is not subject to a particular limitation, i.e. so-called long fibers as well as short fibers or fiber fragments may be used. The length of the fibers may be used to adjust and control the properties of the respective fiber strips over a wide range.

The type of fibers used is not subject to particular limitations either. Only by way of example glass fibers, carbon fibers or polymer fibers such as aramide fibers or fibers based on thermoplastic polymers such as polyesters or polyamides or polyolefins (e.g. polypropylene) shall be mentioned here, which are known to the person skilled in the art with their properties and which are commercially available in great variety. For economic reasons, glass fibers are usually preferred; if e.g. a particular heat resistance is of importance, however, aramide fibers or carbon fibers may be used, which may offer advantages compared to glass fibers when it comes to rigidity or stiffness at higher temperatures.

The lining hoses in accordance with the invention may comprise one fiber strip or more than one fiber strips, which may be the same or different.

Thus, a first fiber strip may preferably be selected from textiles, knitted fabrics, rovings, mats, fleeces or felts, wherein the length of the fibers may be selected in accordance with the desired application. In accordance with a preferred embodiment a first resin impregnated fiber strips is a fiber roving consisting of parallel oriented endless fibers, in particular parallel oriented endless glass fibers. Advantageously the endless fibers are oriented substantially perpendicular to the longitudinal direction of the fiber strip. This first fiber strip can preferably be combined with a second fiber strip, in which the fibers are oriented in a randomly oriented mat in a random manner. The first fiber strip provides a very good rigidity of the lining hose in longitudinal direction, which is of advantage during introduction of the lining hose into the line system to be rehabilitated. The fiber strip located on top with randomly oriented fibers in the form of a random fiber mat stabilizes the inner surface due to its high capacity of resin uptake and avoids pores at the inner surface, which may lead to damages upon extended contact with aggressive media. Through the use of an oriented fiber roving the risk that the fiber mat is pulled apart during the impregnation and thereby a non-uniform impregnation may result, is reduced.

Alternatively in a first fiber strip a fiber roving may be needled or stitched with a randomly oriented fiber mat, i.e. the fiber strip or the fiber strips may also be composed of multiple layers. In this case the randomly oriented fiber mat in the final lining hose preferably forms the inner surface. In some cases it has shown to be advantageous if at least one of the further fiber strips which are located on top of a first fiber strip is composed of multiple layers such that between two layers with randomly oriented fibers an intermediate layer with cut fibers, which preferably have a length in the range of from 2 to 60, preferably of from 3 to 30 cm, oriented parallel to the longitudinal direction of the fiber strip is present.

Further suitable combinations of multiple fiber strips have been described in WO 2011/006618, which is incorporated herein with in its entirety for this purpose. WO 2003/038331 also describes fiber strips respectively endless materials with a suitable composition.

The lining hose in accordance with the invention may comprise a polymer foil (protective foil) on one or both sides of the fiber strip or the fiber strips to achieve a protection against gluing together or damages. Respective foils or films are known to the person skilled in the art and have been described in the literature, so that no details are necessary here.

In this context the term “inner” or “outer” protective foil defines the relative positioning of the respective foil or film after introduction into the line system to be rehabilitated. If the lining hose is introduced in accordance with the so-called inversion process (i.e. by everting) the initial outer protective layer becomes the inner protective layer since the hose is inverted.

With the pre-fabricated lining hoses in accordance with the present invention a sufficient pot-life on one hand and a curing at acceptable temperatures on the other hand is achieved.

The epoxy resin may be deposited by known methods on a fibrous carrier material or the same is impregnated with the resin, e.g. by pulling a fiber strip through a resin bath, by coating with a doctor knife, by kneading-in or by coating under reduced pressure. In some cases it has been shown to be advantageous to increase the viscosity of the resin after depositing same on the fiber strip, e.g. by thickening as described in WO 2006/061129. This can be achieved through the addition of suitable additives or fillers. Thereby, prevention of leaking-out of the still liquid resin out of the impregnated fiber strip can be better achieved.

In accordance with one process the lining hoses in accordance with the invention are manufactured by a winding process, as is e.g. described in WO 95/04646. The width of the fiber strips is not subject to particular limitations; for a large number of applications fiber strips with a width in the range of from 20 to 150, preferably of from 30 to 100 and particularly preferably in the range of form 40 to 80 cm have been found suitable.

Instead of fiber strips which are wound, pre-fabricated fiber structures which already have a tubular form and which may be impregnated with the one-component epoxy resin may also be used in the lining hoses in accordance with the invention. Respective methods for impregnation are known to the person skilled in the art and have been described in the literature.

The thickness of the fiber strips in the lining hose is in accordance with the invention is not subject to particular limitations and is defined through the thickness of the lining hose for the desired application. Fiber strips having a thickness in the range of from 0.01 to 10, preferably of from 0.05 to 5 mm have proved to be suitable.

After the impregnation the resin impregnated fiber strip may be formed to a fiber hose in case of use of a winding process, e.g. in accordance with the winding process described in WO95/04646, optionally in combination with an inner and an outer protective foil or film and optionally a thin fiber fleece. Alternatively it is also possible to impregnate a pre-fabricated fiber hose with the epoxy resin.

A lining hose with a particularly preferred set-up is described in WO2011/06618, which is hereby incorporated by reference in its entirety.

The introduction of the lining hose into a segment of a line system to be rehabilitated may be effected directly, e.g. with the support of a suitable winch or through everting an inverse liner with the support of pressurized air or by pressing in water into the line. This is in particular suitable if—as in a preferred embodiment of the invention—connections to buildings or branch lines, branching from a main sewer line, are to be rehabilitated, as described e.g. in U.S. Pat. No. 6,227,764. Due to the usually smaller diameter of these systems and the changes in direction frequently present pull-in processes are regularly difficult to realize and everting processes have advantages. Evertion processes are known to the skilled person and have been described in the literature, so that no further details have to be given here.

Preferably the lining hoses in accordance with the invention, if the use of evertion processes for the rehabilitation of branch lines is intended, may be open at their upper end and may comprise a so-called hat profile at their lower and which may be brought into contact with the inner wall of the main line. In the interior of the so-called hat profile an expandable carrier may be provided which upon expansion has the effect that the hat profile is attached to the inner wall of the branch line in a tight manner.

The liner is subsequently expanded by e.g. pressurized air so that it comes into direct contact with the interior wall of the line to be rehabilitated.

The lining hoses in accordance with the invention are suitable for the rehabilitation of line systems of any type. By way of example different types of sewer and other wastewater systems as well as pipeline systems in industrial production plants may be mentioned. The lining hoses in accordance with the invention allow the rehabilitation of line systems without the necessity of excavating the line system, which in particular in case of line systems which are only accessible with difficulties, facilitates the use and leads to a significant cost reduction as example given laborious digging works to a major extent are unnecessary. This is in particular advantageous in the rehabilitation of sewer systems in cities, because the no-dig rehabilitation far less detrimentally influences the ongoing traffic compared with the traditional rehabilitation by digging.

1. Pre-fabricated lining hose for the rehabilitation of fluid-carrying systems, comprising at least one resin-impregnated fiber strip wherein the resin is a one-component epoxy resin containing an initiator for chain growth polymerization with an activation temperature of at most 60° C., which is present in the epoxy resin in isolated form.

2. Lining hose in accordance with claim 1 wherein the epoxy resin is processible at a temperature of 20° C. for a period of at least 48 hours.

3. Lining hose in accordance with claim 1, wherein the epoxy resin in the absence of the initiator starts to polymerize at a temperature above 50° C.

4. Lining hose in accordance with claim 1, wherein the epoxy resin is obtained form epoxide compounds with more than one epoxide group in the molecule.

5. Lining hose in accordance with claim 1, wherein the epoxy resin comprises an aliphatic hydroxy compound with more than one hydroxy group in the molecule as additional component.

6. Lining hose in accordance with claim 1, wherein the isolation of the initiator consists of an enveloping or encapsulation of the initiator with a material having a melting point 1 to 20° C. below the intended curing temperature.

7. Lining hose in according with claim 1, which is used for the rehabilitation of branch lines, preferably connection lines to houses (buildings).
